(19) United States
(12) Patent Application Publication
(10) Pub. No.: US 2018/0082389 A1
(43) Pub. Date: Mar. 22, 2018

(54) PREDICTION PROGRAM UTILIZING SENTIMENT ANALYSIS

(71) Applicant: International Business Machines Corporation, Armonk, NY (US)

(72) Inventors: Chinnappa Guggilla, Bangalore (IN); Krishna Kummamuru, Bangalore (IN); Anil M. Omanwar, Kiwale (IN)

(21) Appl. No.: 15/270,599

(22) Filed: Sep. 20, 2016

(51) Int. Cl. G06Q 50/18; G06N 5/02

(52) U.S. Cl. CPC G06Q 50/18; G06N 5/022

(57) ABSTRACT

An approach, executed by one or more computer processors, to determine a sentiment based, at least in part, on one or more statements from one or more sources in a plurality of documents for a proceeding. The approach includes the one or more computer processors predicting an outcome of the proceeding, based, at least in part, on the sentiment.

### BACKGROUND OF THE INVENTION

The present invention relates generally to the field of sentiment analysis and more particularly to automated legal analysis using sentiment analysis of case related documents.

Various approaches exist to perform legal analysis for legal cases. A traditional approach utilized in the legal industry to perform case analysis may include the use of an attorney or a team of attorneys and other legal professionals for research and case analysis. The attorney or the team of legal professionals amass and search extensive quantities of relevant facts, documents, witness statements, related prior legal decisions, opposing lawyer's tactics, relevant case law, assigned judge's prior rulings on similar cases, and other significant legal data including relevant county, state, or federal legal code and laws. Generally, the legal analysis of large quantities of case related information is used to develop a legal strategy or approach for a case that improves the outlook for a positive case resolution for a client. An approach for performing legal analysis for a case using an attorney and/or a team of legal professionals to search extensive amounts of case related information may be both time consuming and expensive.

Recent approaches to the legal analysis of prior information related to a case include the development of automated systems using data mining with natural language processing and machine learning using key word searches to analyze prior related case histories and associated historical case outcomes to predict a case or trial outcome. Prediction engines may provide potential trial outcomes using facts and information extracted from historical related cases. Commonly, prediction engines may use rule-based methodologies or decision trees to provide expected outcomes based on an analysis of the facts in previous cases and case or trial outcomes.

### SUMMARY

Embodiments of the present invention disclose a method, a computer program product, and a system for one or more computer processors to determine a sentiment based, at least in part, on one or more statements from one or more sources in a plurality of documents for a proceeding. The method includes the one or more computer processors predicting an outcome of the proceeding, based, at least in part, on the sentiment.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a prediction program, in accordance with an embodiment of the present invention;

FIG. 3A is an illustration of a user interface displaying an aggregate sentiment score and inputs for display of information for a prediction program, in accordance with an embodiment of the present invention;

FIG. 3B is an illustration of a user interface displaying information generated by a prediction program, in accordance with an embodiment of the present invention;

FIG. 3C is an illustration of a user interface displaying a knowledge graph created using a prediction program, in accordance with an embodiment of the present invention; and

FIG. 4 is a block diagram depicting components of a computer system, in accordance with an embodiment of the present invention.

### DETAILED DESCRIPTION

Embodiments of the present invention provide an automated method of case or proceeding outcome prediction based on a sentiment analysis of various statements generated by key trial participants or case participants using sentiment analysis, natural language processing, and machine learning methodologies. Embodiments of the present invention provide a capability to perform sentiment analysis of case related documents, including written or spoken material provided during human-computer interactions, identifying subjective information to determine a sentiment or a polarity of a group of aggregated statements associated to a source with respect the complaint. Embodiments of the present invention provide a method to apply sentiment analysis to case related documents to predict an outcome of a case based not only on the facts included in what is said, but, on an analysis of a sentiment (e.g., how it is said to determine a level of agreement) and, in particular, how it is said with respect to the complaint. Embodiments of the present invention provide the ability to use similar prior case histories and prior case outcomes as training models to improve machine learning algorithms applied to sentiment analysis used for a prediction of case outcome.

Embodiments of the present invention include a prediction program receiving case related documents and statements, aggregating, and analyzing relationships in statements from case participants or sources such as a defendant(s), witnesses, an arresting officer, and the complainant. Embodiments of the present invention include using machine learning and sentiment analysis of the statements of case participants and other case related documents with respect to the complaint to predict a trial outcome. Embodiments of the present invention predict a trial outcome, based at least in part, on an aggregation of sentiments or an aggregated sentiment score determined for statements or documents from a source such as a key trial participant or a group of related key trial participants such as witnesses with respect to the complaint.

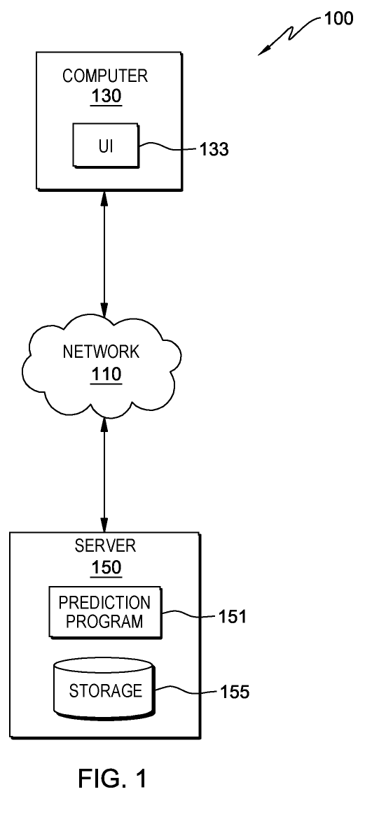

FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

As depicted in FIG. 1, distributed data processing environment 100 includes computer 130 and server 150 interconnected over network 110. Network 110 can include, for example, a telecommunications network, a local area network (LAN), a virtual LAN (VLAN), a wide area network (WAN), such as the Internet, or a combination of the these, and can include wired or wireless connections. Network 110 can include one or more wired and/or wireless networks that are capable of receiving and transmitting data including optical signals, radio waves, and/or video signals, including multimedia signals that include voice, data, and video information. In general, network 110 can be any combination of connections and protocols that will support communications between computer 130, server 150, and other computing devices (not shown) within distributed data processing environment 100.

Computer 130 can be a desktop computer, a notebook, a tablet, a mobile computing device, a web server, a management server or any other electronic device or known computing device capable of receiving, sending and processing data. Computer 130 can be a laptop computer, a computing device used in a server system, or any programmable electronic device capable of communicating with server 150 and other electronic devices in distributed data processing environment 100 via network 110. In an embodiment, computer 130 is a part of a shared pool of configurable computing resources (e.g., networks, servers, storage, applications, and services) that act as a single pool of seamless resources. Computer 130 includes UI 133. UI 133 on computer 130 is any known user interface providing an interface between a user and computer 130, and enables a user of computer 130 to interact with programs and data on computer 130, server 150, and other computing devices (not shown in FIG. 1). In one embodiment, UI 133 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. UI 133 may receive information and data such as instructions, code, and case related documents that may be scanned, typed, or received from an e-mail, received from a database query, another computing device, or other similar source. Case related documents include but are not limited to statements such as witness statements, reports, contracts, or other documents or text corresponding to a case (e.g., a complaint), a trial, a proceeding (e.g., a congressional hearing), a litigation, or another legal activity analyzed by prediction program 151. For the purposes of discussion, case related documents and statements are used interchangeably unless specified as a specific statement, such as a witness statement or a defendant statement.

Server 150 can be a web server, a database server, a management server, a standalone computing device, a desktop computer, a notebook, a tablet, a mobile computing device, or any other electronic device or computing system capable of receiving, sending, and processing data. Server 150 can be a web server, a server system, a laptop computer, or any programmable electronic device capable of communicating with computer 130, and other electronic devices in distributed data processing environment 100 via network 110. In various embodiments, server 150 is a part of a shared pool of configurable computing resources (e.g., networks, servers, storage, applications, and services) that act as a single pool of seamless resources when accessed, for example, in a cloud-computing environment. Server 150 includes prediction program 151 and storage 155. Server 150 can send and receive data such as case related documents, sentiments, sentiment scores, and predictions to and from computer 130 and other computing devices in distributed data processing environment 100 (not shown in FIG. 1). Server 150 may store received case related documents from one or more databases in storage 155. In an embodiment, server 150 sends and receives information from a database resident in one or more other computing devices or storage locations not depicted in FIG. 1. Server 150 may include other programs used in analyzing related case documents or proceeding documents.

Prediction program 151 receives and analyzes case related documents, such as witness statements, in a legal proceeding, such as a case, a trial, a hearing, or other litigation matter, using machine learning and artificial intelligence (AI) techniques in conjunction with sentiment analysis of case related documents to predict a case outcome or trial verdict. Prediction program 151 aggregates statements and/or case related documents by source for extraction of information or logical chunks and domain entities. Logical chunks are related phrases or related segments of text where the relationship can be based on a topic or subject matter in the phrases or text. A domain entity may be a key element of a trial or case. A domain entity may be a named entity related to a case such as people (e.g., witnesses, defendants, complainants, judges, etc.), locations or place names, temporal expressions, a named legal term or concept (e.g., objection, a felony code, custody violation) and the like.

In various embodiments, prediction program 151 uses sentiment analysis of case related documents such as witness statements with respect to another key case element or domain entity. Sentiment analysis of case related documents includes using known methods to leverage natural language processing, text analysis, and computational linguistics to identify and to extract subjective information in source materials including written or spoken material provided during human-computer interactions. In various embodiments, prediction program 151 uses sentiment analysis to determine a polarity or agreement on a subject or a statement in case related documents using emotional classifications such as “positive,” “negative” or “neutral” extracted from text, speech, and in some cases, from visual data. In some instances, sentiment analysis used by prediction program 151 may use advanced polarity methods that consider emotional classifications such as happy, sad, fear, disgust, surprise, and anger. Commonly applied to the written word, sentiment analysis of documents, articles, books, political event reports, and entertainment reviews may occur and can be applied to case related documents such as witness statements by prediction program 151.

In an embodiment of the present invention, prediction program 151 performs sentiment analysis using facial recognition of received digital image data or video of trial participants during a hearing, a trial or a case, for example of a video recording of a trial or an extradition hearing. In general, prediction program 151 utilizes sentiment analysis to probe beyond facts and analyze provided information, such as case related documents, to determine an attitude and/or reaction to a text of a speaker or a statement with respect to a topic or element of a case in the overall context of a trial discussion or a case.

Prediction program 151 uses natural language processing, machine learning and artificial intelligence techniques to extract and aggregate information or statements by a source (e.g., by a witness) to determine relationships within logical chunks and between various domain entities. In various embodiments, prediction program 151 utilizes training sets or provided previous cases and previous case related documents to improve machine learning and artificial intelligence methodologies in prediction program 151. Prediction program 151 may utilize sentiment analysis of prior case histories and outcomes to refine machine learning algorithms.

Prediction program 151 uses sentiment analysis of statements and case related documents aggregated statements by one or more sources with respect to one or more key elements or domain entities of a case. In various embodiments, prediction program 151 generates a sentiment or a sentiment score based on a sentiment analysis of statements from a source such as a witness with respect to a key element of a case such as a complaint or a defendant's statement. A complaint may be any formal legal document that sets out the facts and legal reasons that the filing party or parties (i.e., a complainant or complainants) may use in filing a claim or to request a judgment against a party or parties (i.e., against a defendant or defendants). In an embodiment of the present invention, a complaint includes an arrest record and/or one or more charges filed against a defendant or defendants.

Prediction program 151 provides a sentiment or a sentiment score generated by aggregating sentiments or sentiment scores determined for each related source (e.g., aggregating the sentiment scores or sentiments for each of the witnesses) with respect to one or more statements or documents relating key element or domain entity of the case (e.g., with respect to the complaint or the defendant). A key element of a case or a domain entity may include but is not limited to a complaint, a defendant, a complainant, a report, a witness, a timeframe, etc. In various embodiments, prediction program 151 uses the sentiment or sentiment score generated by aggregating sentiment scores from each source, a group of related sources (e.g., witnesses) or other key case element or domain entity with respect to another source, another key case element or other domain entity of the case, such as the complaint, to predict a case outcome such as an acquittal, a guilty verdict, a settlement, or other legal case outcome. In an embodiment, prediction program 151 provides a predicted case or trial outcome from one or more aggregated sentiments or aggregated sentiment scores. In various embodiments, prediction program 151 determines a predicted case outcome for a case based, at least in part on a determined sentiment for the case and an analysis of other similar previous case histories, associated previous case documents, and associated previous case outcomes. While depicted in FIG. 1 as a single program on server 150, the code and routines of prediction program 151 may be included in one or more programs or applications that may reside in more than one computing device in distributed data processing environment 100.

Storage 155 as depicted in FIG. 1 resides in server 150. Storage 155 may include one or more databases. Storage 155 may receive from server 150 or computer 130 case related documents for storage. Storage 155 may store received case related documents organized by case number, case type, trial identification, case or trial date, by source, or the like. In an embodiment, storage 155 includes provided case histories including trial outcomes (e.g., acquittal, guilty verdict, and/or settlement) in addition to case related documents that may be used in training of a machine learning engine (e.g., training sets) and to refine artificial intelligence methodologies included in prediction program 151. Storage 155 may reside in one or more other computing devices or servers (not shown in FIG. 1).

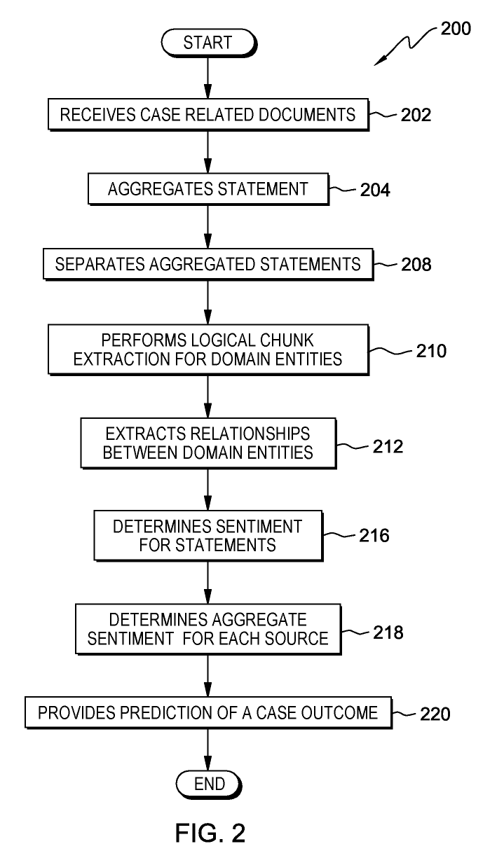

FIG. 2 is a flowchart depicting operational steps of prediction program 151, in accordance with an embodiment of the present invention. As depicted, prediction program 151 includes step 202 through step 220 to predict a case or trial outcome for a complaint or prosecutable offense based on a sentiment determined, based at least in part, on sentiment analysis of various case related documents.

Prediction program 151 receives case related documents (202). Case related documents include, but are not limited to, witness statements, police reports, statements from a defendant or defendants, statements from an accuser or one or more accusers, evidence that is provided in a text format such as invoices, payment receipts, technical reports, supporting documents such as medical reports, land surveys, financial statements, contract copies, and the like. For clarity and ease of reading, a defendant or a group of accused individuals or defendants are identified hereafter as the defendant and an accuser or one or more accusers are identified hereafter as the complainant. In one embodiment, case related documents include digital image data or video related to a case. Case related documents for prediction program 151 are input in server 150, computer 130, or other computing device (not depicted in FIG. 1) by a user, for example, using UI 133 or other user interface (not depicted) and sent to prediction program 151. In an embodiment, case related documents are included in a file or database sent to prediction program 151. In one embodiment, case related documents input in computer 130, server 150, or another computing device (not depicted) for storage in a database (e.g., in storage 155) and retrieval by prediction program 151. Case related documents may be any other case related information, data, or information provided that can be input into a computer such as computer 130 or server 150 and provided to prediction program 151.

Prediction program 151 receives a complete set of statements from the defendant, the witnesses, the investigators, any pre-trial rulings or comments from the judge or judges relating to the case, and any other case supporting documents and information for analysis. In an embodiment, prediction method 200 includes storing received case related documents in storage 155. In one embodiment, prediction program 151 retrieves case related documents from storage 155 or from another database or storage location (not depicted in FIG. 1). In various embodiments, prediction program 151 receives case related documents throughout the trial stage and judgment stage of the trial.

Prediction program 151 aggregates statements (204). For example, prediction program 151 may include aggregating or grouping together statements from a witness or aggregating statements from a group of defense witnesses. Prediction program 151 aggregates the various documents and statements received in step 202 according to the source of the statement. For example, a first eyewitness present at the scene of an accident provides several statements and, later provides answers to additional police investigator questions. In this example, prediction program 151 aggregates or groups together each statement, answer, and comment from the first eyewitness. In another example, prediction program 151 clusters or aggregates each statement, comment, or answer provided by the complainant. In various embodiments, prediction program 151 identifies each set of aggregated statements by the individual or source (e.g., a laboratory or police report) from which the statements or documents are received. In an embodiment, aggregating statements or documents includes grouping together or aggregating a type of statement or document. For example, grouping together or aggregating any technical reports, such as medical reports, laboratory analysis reports, expert witness reports, and forensics reports.

Prediction program 151 separates aggregated statements (208), for example, by page, by paragraph, and by sentence. Decomposing, breaking up, or extracting segments of aggregated statements from a source or a related group of sources (e.g., a group of eyewitnesses) into smaller elements allows deeper processing and analysis of aggregated statements at the micro or sentence level in addition to analysis of a paragraph, a page, or a full statement consisting of multiple sentences to identify relationships and sentiments expressed in a sentence, in a series of sentences on a subject (e.g., a paragraph), and in a full statement. Separating or breaking up aggregated statements provides a deeper or more detailed analysis of relationships of various entities or domain entities with statements from a source (e.g., witness).

Prediction program 151 performs logical chunk extraction for domain entities (210). Domain entities may be people, subjects, locations, or other identified elements important to the case. In an embodiment, a user provides various domain entities input to prediction program 151 for logical chunk extraction. Prediction program 151 may use one or more of natural language processing, analytical linguistics, semantic analysis, data mining, or key word searches to locate and extract logical chunks related to domain entities or one or more specified domain entities. In one embodiment, prediction program 151 provides a pull down menu or icon with various potential domain entities (e.g., a date, a violation code, a location, etc.) for user selection. In an embodiment, prediction program 151 is pre-configured with domain entities based on the type of trial (e.g., a capital offense trial or a land ownership dispute). Examples of domain entities include but, are not limited to a type of violation or violations (e.g., type violation the defendant is charged with), a mentioned person, a witness, a location, an infraction code or penal code related to the specific violation or compliant, a lawyer, a date, a timeframe (e.g., in the first quarter of 2016), a legal concept (e.g., objections, eminent domain), a report (e.g., a medical report or a financial statement), a subject (e.g., a property), and the like.

Prediction program 151 extracts relationships between each of the domain entities in a logical chunk (212). Extracting relationships may occur using clustering, word matching for key words in each domain entity, contextual extraction and context matching performed using known ontological methodologies and natural language processing with semantic analysis.

Prediction program 151 correlates logical chunks with various domain entities using the extracted relationships that provides a deeper understanding and/or insights into a case. Correlating a logical chunk with other logical chunks and various associated domain entities improves case understanding that may evolve other aspects of the case and improve development of a knowledge graph generated from received case related document analysis. Knowledge graphs are known graphical methods to organize and display to a user analysis results on collected information about any domain entity of interest and the relationships between various domain entities. Using known knowledge graphing techniques, knowledge graphs can be quickly updated to provide insights into large volumes of input data such as case related documents. In various embodiments, prediction program 151 includes a visual display or a display of a knowledge graph generated as a result of extracting and correlating relationships in logical chunks with one or more domain entity in received case related documents. In an embodiment, prediction program 151 provides a semantic network of semantic relationships between concepts or domain entities as a form of knowledge representation. A semantic network may be a directed or undirected graph consisting of vertices that represent concepts such as domain entities or key case elements and edges representing semantic relationships between concepts or domain entities.

Prediction program 151 determines a sentiment for statements (216) aggregated by source such as a witness with respect to a domain entity such as the complaint. In various embodiments, prediction program 151 performs a sentiment analysis for statements aggregated by source with respect to a domain entity. Prediction program 151 performs sentiment analysis using methods known to one skilled in the art. In an embodiment, prediction program 151 performs a sentiment analysis by classifying or determining the polarity of a given text at the document, sentence, or topic/domain entity level by analyzing whether the expressed opinion in a document, a sentence or a domain entity is positive, negative, or neutral.

In various embodiments, prediction program 151 performs a sentiment analysis by determining a sentiment by the use of a scaling system whereby words commonly associated with having a negative, neutral or positive sentiment are given an associated number on a −10 to +10 scale (most negative to most positive). Using this known methodology, prediction program 151 may adjust the sentiment of a given term relative to its environment (usually on the level of the sentence). For example, when prediction program 151 analyzes a piece of unstructured text using natural language processing, each topic or domain entity in the specified environment (e.g., a sentence or a statement) is given a score, for example, a sentiment score. The score is based on the way sentiment words relate to the domain entity and its associated level of negative or positive score determined by a scale (−10 to +10). Using the above approach allows prediction program 151 to provide a more sophisticated understanding of sentiment, adjusting the sentiment value of a topic or domain entity relative to words, for example, that intensify, relax or negate the sentiment expressed by the topic or domain entity.

In various embodiments, prediction program 151 expresses the determined sentiment as a sentiment score that is a numerical or a graphical representation of a sentiment. For example, a sentiment or a sentiment score is depicted as an element (e.g., a bar) in a graph or other visual representation of sentiments for the case or proceeding. In another example, a sentiment associated with a negative response or a low level of correlation is expressed as −3, which is a numerical sentiment score configured in prediction program 151 to range between −5 and +5 to express the determined sentiment. In yet another example, a sentiment is expressed as a percentage such as 80% for a sentiment score where 80% represents a high level of agreement or a positive sentiment generated from a sentiment analysis of a witness's statements with respect to a complaint. In an embodiment, a sentiment is expressed in words. For example, prediction program 151 provides a sentiment as one or more words such as strongly positive, neutral, weakly negative or weak disagreement and the like describe a positive sentiment, a neutral sentiment, or a negative sentiment generated as a result of a sentiment analysis.

In various embodiments, a sentiment is determined, at least in part, on a level of correlation or agreement between the statements from a source (e.g., a witness) or a group of related sources (e.g., prosecution witnesses) and the complaint. For example, the correlation is determined by comparing the information extracted and aggregated to the complaint for a level of agreement, disagreement (i.e., deviation) or neutrality with the complaint. Using known ontology learning methodologies including natural language processing with deep learning for extraction of identified logical chunks associated with domain entities and semantic analysis of aggregated statements occurs to determine sentiments expressed in one or more statements from a source with respect to another source or domain entity. In various embodiments, prediction program 151 uses a legal ontology developed based on legal terminology and information on legal concepts compiled or included in prediction program 151. For example, a legal ontology is compiled and developed for prediction program 151 that includes various legal terms, legal definitions, and legal concepts to analyze one or more case related documents using sentiment analysis. In some examples, prediction program 151 accesses one or more databases of legal terms configured for a type of legal area or dispute such as land ownership, felony offense trials, legal custody disputes, traffic infractions, or the like. In various embodiments, a sentiment is determined based, in part, on a comparison of two or more domain entities using sentiment analysis and various known statistical methods.

In an embodiment, prediction program 151 determines a sentiment based on a level of correlation or agreement with respect to another witness's statement. For example, a sentiment is determined based on a comparison using sentiment analysis of eyewitnesses' statements toward the other witness (a sentiment based on statements of the eyewitness relating to the other witness's statements). In this example, sentiment analysis of the statements aggregated from eyewitness 1 are compared or correlated with respect to statements aggregated from eyewitness 2, and then, the statements aggregated from eyewitness 1 are correlated to statements from eyewitness 3, and so on. The sentiment, in this example, may be determined for eyewitness 1's statements relative to the other eyewitnesses' statements. For example, a comparison of the sentiments relating to eyewitness 1's statements with respect to eyewitnesses 2, 3, 4, and 5 may show that eyewitness statements from eyewitnesses 2, 3, and 5 result in a high level of agreement of terms used in each statement correlated with associated eyewitness 1's statements resulting in a positive sentiment. In an embodiment, prediction program 151 highlights or identifies to a user outlier sentiments. For example, eyewitness 4's resulting sentiment is significantly different from sentiments or eyewitnesses 2, 3, and 5 with respect to eyewitness 1. Prediction program 151 may highlight a sentiment associated to eyewitness 4 as an outlier sentiment as compared to sentiment scores of eyewitnesses 2, 3, and 5. Receiving a notification of eyewitness 4's sentiment as outlier may suggest or indicate to a user (e.g., a lawyer) that eyewitness 4 did not have as good a view of an incident as eyewitnesses 1,2, 3, and 5 which may be an insight used in determining a case strategy.

In various embodiments, a user selects a domain entity to correlate a level of agreement or deviation with respect to at least one other domain entity. For example, prediction program 151 determines a sentiment, for example, a sentiment of −3 on a scale of −5 to 5, based on a user selection of a domain entity of an eyewitness for sentiment analysis determined with respect to or toward a defendant (e.g., based on extracted statements from the complaint relating to the defendant). In an embodiment, prediction program 151 predicts a negative trial outcome for the defendant based, at least in part, on the previous case outcomes and an analysis of associated previous similar case histories and the associated previous sentiment (e.g., −3) determined for an eyewitness statements with respect to a defendant. In various embodiments, prediction program 151 is capable of performing numerous user selected sentiment analyses of one or more domain entities and to predict a case outcome by comparing similar sentiment analyses on previous cases or provided case histories (e.g., provided for machine learning training and/or retrieved from storage 155) and associated case outcomes.

In one embodiment, prediction program 151 determined a sentiment from a sentiment analysis of a source's statement toward the same domain entity as another source's statements toward the domain entity. For example, a sentiment analysis is performed for eyewitness 1's statements relating to the domain entity of an event such as a contract negotiation on liability and an insurance company negotiator's statements regarding the contract negotiation on liability. Based on previous similar case history analysis of sentiments generated based on statements of a witness and an insurance company negotiator on similar liability negotiations, prediction program 151 predicts an expected outcome based, at least in part, on the determined sentiment.

In an embodiment, prediction program 151 receives digital image or video of a trial or pre-trial proceedings and provides sentiment analysis using known facial feature recognition techniques to determine a sentiment of a witness. A sentiment for witness, defendant, or other case significant individual determined from captured digital images or video may be provided as a separate data point along with various other determined sentiments related to the witness, defendant, or other significant individual for a case (e.g., a judge). In one embodiment, sentiment analysis of statements from case related documents includes an analysis of annotations in a trial or case record such as “witness paused for ten seconds before responding” included in textual transcripts of a statement.

In an embodiment, prediction program 151 performs sentiment analysis of pre-trial testimony, pre-trail rulings, and depositions from a source or a group of related sources or with respect to another source or sources (e.g., the complaint).

Prediction program 151 determines an aggregated sentiment for each source (218), for example, each witness. In this embodiment, prediction program 151 aggregates each sentiment or sentiment score for each statement of a source (e.g., a witness) determined with respect to the complaint to create an aggregated sentiment or an aggregated sentiment for a source (e.g., a witness) with respect to the complaint.

In an embodiment, prediction program 151 determines an aggregated sentiment based, at least in part, on an analysis of various statements by a source, such as a witness, with respect to the statements of the defendant. In one embodiment, prediction program 151 determines an aggregated sentiment for a witness determined with respect to each of the other witnesses. In various embodiments, prediction program 151 aggregates sentiments determined for a group or set of related sources such as aggregating the sentiments determined from a group of witnesses (e.g., a group of testifying witnesses, a group of prosecution witnesses, a group of eyewitness, a group of defense witnesses, a group of expert witnesses, etc.) evaluated with respect to a level of agreement or disagreement or deviation from one of the complaint, the complainant, the defendant, or other key case element.

In various embodiments, prediction program 151 aggregates sentiments for a group of related sources. For example, prediction program 151 aggregates a sentiment determined for each defense witness into an aggregated sentiment for defense witnesses with respect to a key case element or domain entity, such as the complaint or the complainant. In another example, prediction program 151 aggregates a sentiment determined for each expert witness's statements with respect to the complaint into an aggregated sentiment for the group of expert witnesses with respect to the complaint.

In an embodiment, prediction program 151 provides an aggregated sentiment determined from statements extracted relative to a domain entity with respect to another domain entity. For example, an aggregated sentiment for a domain entity such as a complaint determined with respect to another domain entity such as a defendant may analyze the correlation of complaint's statements as compared to a defendant's statements. In this example, the comparison determines a level of agreement or a positive sentiment determined from a sentiment analysis of subjective subject matter that may indicate an attitude or sentiment of the complaint with respect the defendant. Based, at least in part, on previous case history analysis (e.g., for training machine learning) indicating a negative sentiment determined based on the sentiment analysis of the complaint's statements and the defendant's statements, prediction program 151 may provide a prediction of a negative case outcome for the defendant (e.g., guilty).

In an embodiment, prediction program 151 includes a user selection of one or more sources or groups of related sources to determine an aggregated sentiment with respect to a user selection of one of a complaint, a defendant, or another group of related sources. A group of related sources may include but is not limited to a group of eyewitnesses, a group of defense witnesses, a group of prosecution witnesses, a group of expert witnesses, one or more reports, contracts, regulations (e.g., related group of state and/or federal regulations, laws, or codes) or other related group of documents for a case, etc.).

In various embodiments, prediction program 151 trains a machine learning engine using previously discussed methods such as natural language processing with semantic analysis, data mining techniques, and sentiment analysis on previously completed similar cases or similar case histories retrieved, for example from storage 155. For example, prediction program 151 uses previous similar case histories to determine historical sentiment determined from aggregated sentiments from the various witnesses with respect to the complaint. In another example, a sentiment or an aggregated sentiment score of the defendant's statements with respect to a complaint as discussed above and determines a predicted case outcome based, at least in part, on the aggregated sentiment score.

Prediction method 200 includes using sentiment analysis with a machine learning model trained from a rich case history to determine an aggregated sentiment based on one or more sentiments determined for a source with respect to a key case element or domain entity such as the complaint. Using machine learning along with clustering techniques for logical chunk extraction relationship determination between domain entities, sentiment analysis as discussed in the previous step on historical case histories, and comparing aggregated sentiment with actual trial or case outcomes further refines and improves the prediction trial outcomes use of prediction program 151 provides.

Prediction program 151 provides a prediction of a case outcome (220) based on a sentiment. In various embodiments, prediction program 151 presents a case outcome as acquitted, guilty, or a settlement, based, at least in part, on a determined aggregated sentiment. For example, a sentiment (e.g., expressed as an aggregated sentiment score) is an aggregated sentiment determined with respect to key case elements aggregated for a group of related sources (e.g., an aggregation of aggregated sentiment scores or sentiments for each of the witnesses with respect to the complaint). In an embodiment, prediction program 151 provides the predicted outcome as a sentiment score. For example, prediction program 151 provides a predicted outcome for a case as +9. A provided sentiment score of +9 in a scale of −10 (most negative sentiment) to 10 (most positive sentiment) corresponds to a very high probability of a positive case outcome or “not guilty. In one embodiment, prediction method 200 includes a pre-configured determination of a case outcome based on an aggregated sentiment for all witnesses determined or correlated with respect to the complaint.

In various embodiments, prediction program 151 determines a prediction based, at least in part, on a sentiment that is an aggregated sentiment core that is presented in the form of a positive, a neutral or a negative number. The positive, negative, or neutral number represent a sentiment or a level of agreement or a level of disagreement with respect to key case element or domain entity such as the complaint that is used to predict a case outcome. For example, based, in part on a comparison of the results of previous sentiment analysis previous case histories for an aggregated sentiment and corresponding case outcomes, prediction program 151 provides a predicted case outcome corresponding to the determined aggregated sentiment. For example, an aggregated sentiment resulting from aggregation the sentiments resulting from a sentiment analysis of each of the defendants statements with respect to the complaint may result in an aggregated sentiment score of 70 in a sentiment score of 0 (extremely negative level of agreement) to 100 (an ideal positive level of agreement). In this example, based on an aggregated sentiment score of 70, prediction program 151 predicts a not guilty verdict for the defendant.

In one embodiment, a range of positive or negative sentiments aggregated from source such as each witness's statements with respect to a complaint determines a predicted trial outcome. For example, in a sentiment such as an aggregated sentiment score based on a range of −10 to +10 for potential sentiment scores or sentiments, prediction program 151 is configured so that a range of aggregated sentiment scores of −4 to −10 provide a predicted case outcome of a guilty verdict. In an embodiment, prediction program 151 provides a predicted case outcome is based, at least in part, on a sentiment or an aggregated sentiment as words or a verbal description. For example, based on aggregated sentiment such as “mildly positive.” prediction program 151 provides a low or moderate chance of an acquittal. In an embodiment, a confidence level is associated with an aggregated sentiment score. For example, an aggregated sentiment score of −7 has an associated 85% probability of receiving a guilty verdict or case outcome of a guilty verdict.

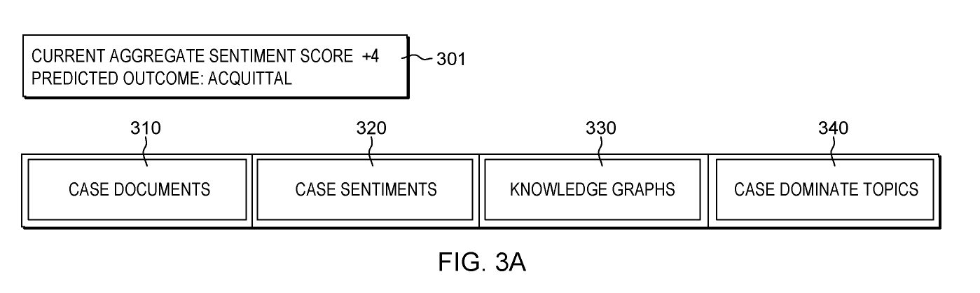

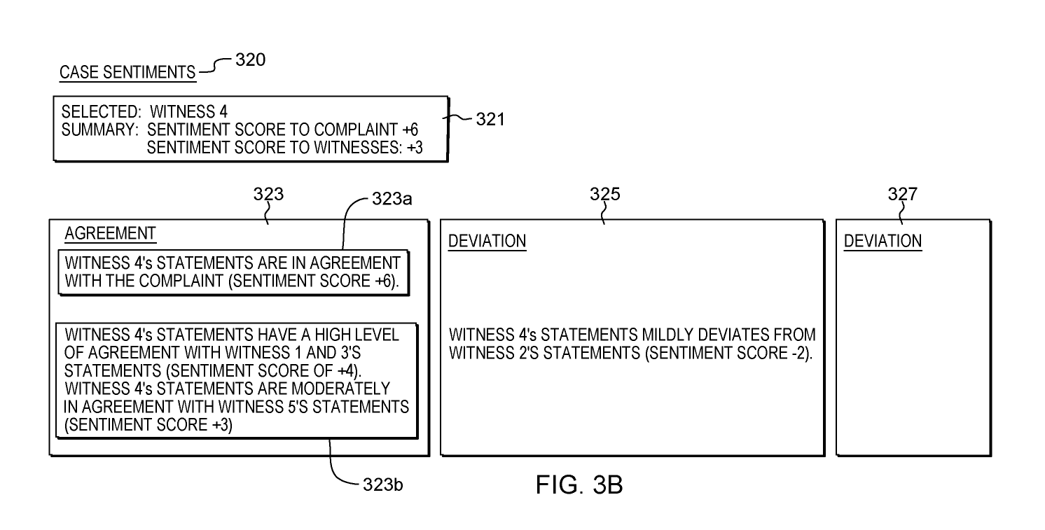

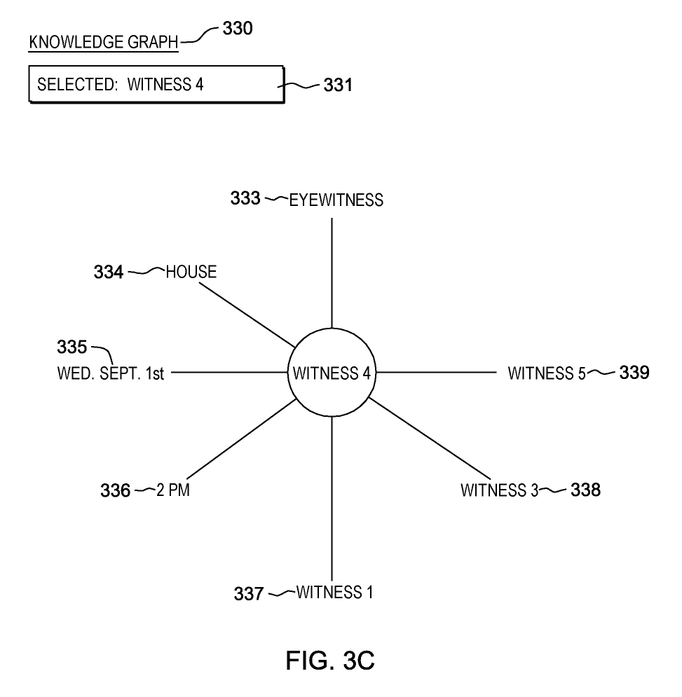

FIG. 3A is an illustration of a user interface displaying an aggregate sentiment score and inputs for display of information for a prediction program 151, in accordance with an embodiment of the present invention. As depicted, FIG. 3A includes an example of an aggregate sentiment score depicted as aggregate sentiment score 301, case documents 310, case sentiments 320, knowledge graph 330, and case dominate topics 340. FIG. 3A provides an example of a display provided to user, for example in UI 133 on computer 130 by prediction program 151. Computer 130 may receive via UI 133 a user request or selection on UI 133 of one or more elements such as case documents 310 to display to the user one or more selections and/or outputs received via network 110 to or from prediction program 151 on server 150.

A user selecting to access prediction program 151 via an input on UI 133 may select one of the file names or numbers relating to a specific case (e.g., for a trial) displayed by prediction program 151 but, not depicted in FIG. 3A. FIG. 3A is an example of a data display for a selected case or trial provided by prediction program 151 in response to a case selection by a user. As depicted in FIG. 3A, computer 130 may display a current aggregate sentiment score in aggregate sentiment score 301 and may include a predicted outcome such as “acquittal” as determined and provided by prediction program 151 based on one or more sentiment analyses of case related documents for the case. As a trial or case progresses and additional case related documents are added to prediction program 151, for example, using case documents 310, aggregate sentiment score 301 may automatically change or update to provide another current aggregate sentiment score or another updated predicted outcome, for example, neutral or “unknown”.

In various embodiments, prediction program 151 determines an aggregate sentiment score displayed in aggregate sentiment score 301 as “Current Aggregate Sentiment Score” according to a program default to determinate the aggregate sentiment score. For example, prediction program 151 determined the aggregate sentiment score by aggregating the sentiment score for each witness with respect to a level of agreement with the complaint according to the method previously discussed with respect to FIG. 2. In an embodiment, prediction program 151 determines and updates aggregate sentiment score based on a user selection of a domain entity with respect to another selected domain entity to determine aggregated sentiment score. For example, a user may select to create or determine a current aggregate sentiment score for aggregate sentiment score 301 based on an analysis of a defendant's statements extracted from the case related documents correlated for a level of agreement with respect the complainant's statements.

Additionally, UI 133 may provide a number of tabs such as case sentiments 320. If selected by a user, each of the tabs provide additional information or data to the user as discussed below. While depicted in FIG. 3A as tabs, an icon, a pull-down menu, or other known display method for receiving a user's selection may be used by prediction program 151.

A selection of case documents 310 from UI 133 provides the user with the ability to input case related documents in to prediction program 151. For example, upon selecting case documents 310, a user may attach or enter a file name and location, paste text, or using known methods otherwise add text from case related documents and click on a “submit” button or press “enter” to process and save the document. In an embodiment, a user enters a witness identification (e.g., a name) on UI 133 sent via network 110 to prediction program 151. In one embodiment, one or more domain entities (e.g., a location and time) related to the input case documents or statement are input to UI 133 by a user for transmission to prediction program 151. In various embodiments, prediction program 151 receives case related documents entered by a user on UI 133 that includes a case or trial identification (e.g., a case number). In an embodiment, prediction program 151 receives from a user digital image data or video captured during a trial, a pre-trial hearing, or that is presented as evidence in a trial or a case. In one embodiment, user inputs a location or database for retrieving documents to submit to prediction program 151 using an input on UI 133 in case documents 310. Upon selecting “submit” or “enter,” for example, the case related document is sent to prediction program 151 for processing (e.g., for aggregating case related documents or statements by witness, by the accused, or by the complaint, etc.). A user selection of case sentiments 320 and knowledge graph 330 in prediction program 151 as depicted in FIG. 3A are discussed later with respect to FIGS. 3B and 3C respectively.

In various embodiments, a user selection of case dominate topics 340 may display three or four topics identified by keyword analysis of all case related documents for a specific case and/or trial. Most frequently discussed topics as determined by semantic analysis and keyword search are displayed upon selection of case dominate topics 340. In an embodiment, a user enters keywords for analysis of the frequency in the case related documents. In one embodiment, prediction program 151 provides both a frequency for the case dominate topics and a frequency for a user entered keyword.

FIGS. 3B is an illustration of a user interface displaying information for prediction program 151, in accordance with an embodiment of the present invention. As depicted, FIG. 3B includes case sentiments 320, summary 321, agreement 323, deviation 325, and neutral 327. FIG. 3B is an example of a display provided to a user in UI 133 in response to a selection of case sentiments 320. In a display of case sentiments 320, prediction program 151 provides information for summary 321, agreement 323, deviation 325, and neutral 327 for a selected domain entity with respect to another selected domain entity.

Case sentiments 320 includes summary 321 for a domain entity or a selected witness. In an embodiment, sentiment score for the selected witness with respect to the complaint is depicted in summary 321. Summary 321, as depicted, includes sentiment score to complaint +6 where +6 is the aggregated sentiment score for the selected witness or witness 4 with respect to the complaint.

Summary 321 also includes sentiment score all witnesses shown as +3. Prediction program 151 using the method previously discussed with respect to FIG. 2 determines an aggregate sentiment score based on compiling or aggregating the sentiment score from each witness with respect to the selected witness. In this example, a sentiment score for the witnesses depicted as “sentiment score witnesses: +3” in summary 321 is based, at least in part, on the aggregation and analysis of the correlation of witness 4's statements to each of the other witnesses' statements (e.g., a sentiment score determined for witness 1, 2, 3, and 5 using sentiment analysis with respect to witness 4).

In an embodiment, summary 321 includes a user selection for determining a sentiment score for each of the various witnesses with respect to a complaint aggregated when a witness selection of “all” for the selected witness (not depicted in FIG. 3B) is provided to prediction program 151. In this example, sentiment score to the complaint may be determined by aggregating each of the sentiments or sentiment scores for the various witnesses determined with respect to the complaint.

Agreement 323 depicts the level of agreement or sentiment score for the selected witness (e.g., witness 4) with respect to the complaint (i.e., sentiment score to complaint +6) as depicted agreement 323a (in the first two lines of agreement 323).

Agreement 323b, the second section or group of lines (i.e., lines 3-8), in agreement 323 depict the sentiment score or the level of agreement between the statements of witness 4 with respect to each of the other witnesses (e.g., with respect to witness 1, 3, and 5) extracted from the case related documents and analyzed by prediction program 151. The level of agreement or sentiment for each witness such as “a high level of agreement” for witnesses 1 and 3 or “moderately in agreement” for witness 5 with respect to witness 4 are depicted in lines 3-8 of agreement 323.

As depicted in FIG. 3B, a sentiment score for witness 2 is not included in agreement 323b but, is included under deviation 325 as the sentiment analysis by prediction program 151 of the statements provided by witness 2 are not in agreement with the statements provided witness 4.

Deviation 325 includes a sentiment score for the level of deviation or disagreement of Witness 2's statements with respect to witness 4. As depicted in FIG. 3B, the analysis of witness 2's statements determines that a minor disagreement or deviation occurs between witness 4's statement and witness 2's statement. The sentiment score −2 is determined for witness 4 with respect to witness 2.

Neutral 327 is empty as the sentiment analysis with respect to the complaint and with respect to each of the witnesses were not neutral for the provided case related documents analyzed by prediction program 151. Therefore, no information was provided to UI 133 by prediction program 151 for display in neutral 327 for witness 4.

FIGS. 3C is an illustration of a user interface displaying an example of knowledge graph 330 created using prediction program 151, in accordance with an embodiment of the present invention. As depicted, FIG. 3C includes knowledge graph 330, selected 331, domain entities 333-39 that include eyewitness 333, house 334, Wed., September 1^{st} 335 (i.e., date), 2 pm 336 (i.e., time), witness 1 337, witness 3 338, and witness 5 339. FIG. 3C is one example of a knowledge graph 330 created using prediction program 151.

In an embodiment, prediction program 151 is configured with a default knowledge graph 330 created based on information extracted for a selected domain entity or a selected witness, such as witness 4 that is provided to UI 133 in computer 130. In an embodiment, knowledge graph 330 is composed of domain entities selected by a user after receiving a user selection of knowledge graph 330 and a witness selection. A witness selection may be provided by a user selection on a pull-down menu of witnesses for the case (not depicted) provided by prediction program 151 via network 110 to UI 133. In various embodiments, prediction program 151 creates knowledge graph 330 and sends to UI 133.

In one embodiment, prediction program 151 provides knowledge graph 330 with domain entities 333-339 are domain entities determined by prediction program 151 to be related to witness 4. For example, prediction program 151 determines that domain entities such as an identification of witness 4 as an eyewitness, a location of witness 4 (e.g., house), and so on based at least in part, on the logical chunk extraction for domain entities and the extraction of relationships between logical chunks determined using semantic and sentiment analysis techniques. In one embodiment, prediction program 151 provides knowledge graph 330 where the length of the radii related to the number of references in case related documents to a domain entity with respect to or in relation to the selected domain entity.

In various embodiments, prediction program 151 creates knowledge graph 330 where each of the radii (e.g., time 2 pm 335) depicts a sentiment score for a selected domain entity or selected witness displayed in selected 331 respect the statements relating to the radii or each radii domain entity in a key case element such as the complaint, the defendant, etc. In an embodiment, the length of the radii and/or a color of the radii are associated with the aggregated sentiment score or sentiment. For example, the larger the aggregated sentiment score related to one of the radii for a domain entity, the longer the radius representing the domain entity. In another example, using the information previously depicted in FIG. 3B, prediction program 151 determines the length of the radii of knowledge graph 330 based, on the sentiment score (e.g., radius for witness 1 333 with respect to witness 4 corresponds to a sentiment score of +4). Additionally, the radii may be further differentiated by a color of each of the radii. For example a positive aggregated sentiment score or sentiment may be represented as a blue radius while a negative aggregated sentiment score may be represented in red. In various embodiments, knowledge graph 330 is generated using a sentiment analysis of a user selected element, domain entity, or witness with respect to a user selection of a complaint, a defendant's statements, and/or another selected domain entity. Knowledge graph 330 may provide a quick insight into trial outlook and direction. A comparison of various versions of knowledge graph 330 generated as the trial progresses may provide an indication of the progress and trial outlook developments based, at least in part, on a sentiment analysis of case related documents and/or statements.

In one embodiment, prediction program 151 provides UI 133 a selection of a number of knowledge graph formats that may be selected by a user for display of data determined as a result of an analysis using sentiment analysis of extracted and clustered information from case related documents for a trial. In response to a user selection of a knowledge graph format, prediction program 151 provides the data and knowledge graph using the selected format for selected 331 (e.g., a witness).

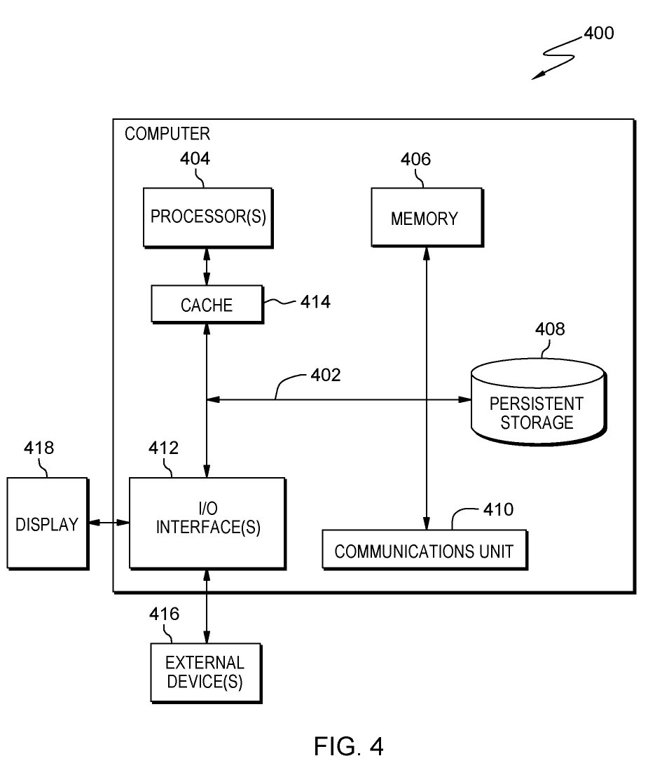

FIG. 4 is block diagram 400 depicting components of a computer system in accordance with an embodiment of the present invention. As depicted, FIG. 4 depicts the components of computer 130 or server 150, within distributed data processing environment 100. It should be appreciated that FIG. 4 provides only an illustration of one implementation and does not imply any limitations with regard to the environments in which different embodiments can be implemented. Many modifications to the depicted environment can be made.

Computer 130 and server 150 can include processor(s) 404, cache 414, memory 406, persistent storage 408, communications unit 410, input/output (I/O) interface(s) 412, and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is part of persistent storage 408.

Communications unit 410, in these examples, provides for communications with other data processing systems or devices, including resources, computer 130, server 150, and other computing devices not shown in FIG. 1. In these examples, communications unit 410 includes one or more network interface cards. Communications unit 410 may provide communications with either or both physical and wireless communications links. Program instructions and data used to practice embodiments of the present invention may be downloaded to persistent storage 408 through communications unit 410.

I/O interface(s) 412 allows for input and output of data with other devices that may be connected to computer 130 or server 150. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method comprising:
determining, by one or more computer processors, a sentiment based, at least in part, on one or more statements from one or more sources in a plurality of documents for a proceeding; and
predicting, by one or more computer processors, an outcome of the proceeding, based, at least in part, on the sentiment.

2. The method of claim 1, further comprises:
determining, by one or more computer processors, a sentiment of each of the one or more sources in a group of related sources;
aggregating, by one or more computer processors, a plurality of sentiments of each of the one or more sources in the group of related sources; and
predicting, by one or more computer processors, the outcome of the proceeding, based, at least in part, on the plurality of sentiments for the group of related sources.

3. The method of claim 1, wherein determining the sentiment used to predict the outcome further comprises determining, by one or more computer processors, the sentiment with respect to at least one of a complaint, a defendant's statements, a complainant's statements, or statements relating to another key case element.

4. The method of claim 1, wherein determining the sentiment based, at least in part, on the one or more statements from the one or more sources in the plurality of documents further comprises expressing, by one or more computer processors, the sentiment as one of a numerical sentiment score, an element in a graph, or at least one descriptive word.

5. The method of claim 2, wherein aggregating the plurality of sentiments for the each of the one or more sources of the group of related sources further comprises:
aggregating, by one or more computer processors, each statement from a source of the one or more sources in the group of related sources,
aggregating, by one or more computer processors, a sentiment determined for one or more statements from each source of the one or more sources in the group of related sources; and
aggregating, by one or more computer processors, an aggregated sentiment for each source of the one or more sources in the related group of sources.

6. The method of claim 2, wherein the one or more sources in the group of related sources includes at least a group of: a plurality of witnesses, a plurality of eyewitnesses, a plurality of defense witnesses, a plurality of prosecution witnesses, a plurality of expert witnesses, a plurality of reports, a plurality of contracts, and a plurality of other documents related to a case.

7. The method of claim 1, wherein determining the sentiment based, at least in part, on the one or more statements from the one or more sources further comprises:
aggregating, by one or more computer processors, the one or more statements from one or more witnesses, from one or more defendants, by one or more complainants, and in a complaint;
separating, by one or more computer processors, the one or more aggregated statements by page, by paragraph, and by sentence;
performing, by one or more computer processors, logical chunk extraction for at least one domain entity on the one or more aggregated statements; and
extracting, by one or more computer processors, one or more relationships between at least one selected domain entity and other domain entities using one or more of data mining, natural language processing, semantic analysis, a legal ontology, machine learning and artificial intelligence.

8. The method of claim 7, wherein the at least one domain entity includes one or more of a person, a location, a date, a penal code, a legal term, a report, a time, and a timeframe.

9. The method of claim 1, further comprises:
determining, by one or more computer processors, a graphical representation of at least one relationship between at least one selected domain entity and at least one other domain entity, and a sentiment determined for the at least one other domain entity with respect to the at least one selected domain entity.

10. The method of claim 1, wherein predicting the outcome of the proceeding, based, at least in part, on the sentiment further comprises predicting, by one or more computer processors, an acquittal based on a positive sentiment, a guilty verdict based on a negative sentiment, and an unknown prediction for a neutral sentiment.

11. The method of claim 1, wherein the proceeding includes at least one of a trial, a legal case, a litigation, and a hearing.

12. A computer program product comprising:
one or more computer readable storage media and program instructions stored on the one or more computer readable storage media, the program instructions executable by a processor, the program instructions comprising instructions for:
determining a sentiment based, at least in part, on one or more statements from one or more sources in a plurality of documents for a proceeding; and
predicting an outcome of the proceeding, based, at least in part, on the sentiment.

13. The computer program product of claim 12, further comprises:
determining a sentiment of each of the one or more sources in a group of related sources;
aggregating a plurality of sentiments of each of the one or more sources in the group of related sources; and
predicting the outcome of the proceeding, based, at least in part, on the plurality of sentiments for the group of related sources.

14. The computer program product of claim 121, wherein determining the sentiment used to predict the outcome further comprises determining the sentiment with respect to at least one of a complaint, a defendant's statements, a complainant's statements, or statements relating to another key case element.

15. The computer program product of claim 12, further comprises:
determining a graphical representation of at least one relationship between at least one selected domain entity and at least one other domain entity, and a sentiment determined for the at least one other domain entity with respect to the at least one selected domain entity.

16. The computer program product of claim 12, wherein predicting the outcome of the proceeding, based, at least in part, on the sentiment further comprises predicting an acquittal based on a positive sentiment, a guilty verdict based on a negative sentiment, and an unknown prediction for a neutral sentiment.

17. A computer system comprising:
one or more computer processors;
one or more computer readable storage media; and
program instructions stored on the one or more computer readable storage media for execution by at least one of the one or more computer processors, the program instructions comprising instructions for:
determining a sentiment based, at least in part, on one or more statements from one or more sources in a plurality of documents for a proceeding; and
predicting an outcome of the proceeding, based, at least in part, on the sentiment.

18. The computer system of claim 17, further comprises:
determining a sentiment of each of the one or more sources in a group of related sources;
aggregating a plurality of sentiments of each of the one or more sources in the group of related sources; and
predicting the outcome of the proceeding, based, at least in part, on the plurality of sentiments for the group of related sources.

19. The computer system of claim 17, wherein determining the sentiment based, at least in part, on the one or more statements from the one or more sources further comprises:
aggregating the one or more statements from one or more witnesses, from one or more defendants, by one or more complainants, and in a complaint;
separating the one or more aggregated statements by page, by paragraph, and by sentence;
performing logical chunk extraction for at least one domain entity on the one or more aggregated statements; and
extracting one or more relationships between at least one selected domain entity and other domain entities using one or more of data mining, natural language processing, semantic analysis, a legal ontology, machine learning and artificial intelligence.

20. The computer system of claim 17, wherein predicting the outcome of the proceeding, based, at least in part, on the sentiment further comprises predicting an acquittal based on a positive sentiment, a guilty verdict based on a negative sentiment, and an unknown prediction for a neutral sentiment.
